(19) United States
(12) Patent Application Publication
(10) Pub. No.: US 2012/0143664 A1
(43) Pub. Date: Jun. 7, 2012

(54) REWARD METHOD AND SYSTEM FOR USERS OF ELECTRONIC COMMERCE

(76) Inventor: JOHN Christopher MADDOX, Huntington Woods, MI (US)

(21) Appl. No.: 12/961,203

(22) Filed: Dec. 6, 2010

(51) Int. Cl. G06Q 30/00

(52) U.S. Cl. 705/14.16; 705/14.1

(57) ABSTRACT

The present invention relates to methods and systems of providing rewards for users of electronic commerce making donations to non profit using such rewards. The methods include creating a unique user identification and tracking the Users spending at various affiliates. The User rewards is based on the amount of spending at the affiliate. Rewards may also be given to the Referrer based on the spending of the referred User.

### BACKGROUND

The present invention relates to methods and systems of providing rewards for users of electronic commerce making donations to non profit using such rewards.

It has become very popular to buy products and services using on line stores. Almost all brick and mortar stores have some sort of on line version where you can shop from the privacy and convenience of your own home. These online stores generally pay a commission to sites that direct web traffic to their on line shopping site. There is a desire to create more incentives to direct web traffic to on line stores.

### SUMMARY OF THE INVENTION

Applicant has addressed the need to direct more web traffic to certain on line stores by creating a reward system which encourages Users to visit particular on line stores and to encourage User to get other Users on the service.

The present invention relates to a computer implemented method of providing rewards. Information about a User is stored in a computer. The method facilitates sending the User to an affiliate along with certain identifying information about the User. The computer receives information about the User's activities and or spending at the affiliate from the affiliate. The User is then credited rewards based on his purchases from the affiliate.

Another embodiment of the present invention includes a computer system having software which stores information about a User in a computer. The software receives information about the User's purchases from an affiliate and then gives the User rewards based on purchases from the affiliate. The computer system may also have software to run a compatible site, wherein the software to run the compatible site may be integrated with the software to provide a User with rewards.

In yet another embodiment of the present invention, a method of donating to a non profit is disclosed. The method includes having Users sign up to a computer managed service. The method includes creating a unique user identification for each User. The method further involves facilitating sending the User to an affiliate with the unique user identification. Next, information from the affiliate including at least the unique user identification and the amount of money spent is received by the service. The User receives rewards based on the amount of money spent by the User at the affiliate. Lastly, the method facilitates the User to select an non profit and allowing the User to direct rewards to the non profit selected.

In yet another embodiment of the present invention, a method of providing a referral reward including have User sign up to a service wherein the User designates a Referrer is disclosed. A unique user identification is created for each User. The method facilitates sending the User to an affiliate along with the unique user identification. The service then receives information from the affiliate including at least the unique user identification and the amount of money spent. The User is assigned User rewards based on the amount of money spent by the User at the affiliate. Lastly, the Referrer is assigned rewards based on the amount of money spent by the User at the affiliate.

### BRIEF DESCRIPTION OF THE DRAWINGS

FIG. 1 depicts and exemplary block diagram of a method of providing rewards;

FIG. 2 depicts an exemplary computer system capable of running the programs below;

FIG. 3 depicts and exemplary block diagram of a method of donating rewards to non profit; and

FIG. 4 depicts and exemplary block diagram of a method of providing referral rewards.

### DETAILED DESCRIPTION

The present invention utilizes the world wide web and the methods and systems described below (collectively referred to LeapNgo) to facilitate communications between persons and affiliates to credit Users with rewards for visiting affiliate sites, for donating those rewards to charities, and for rewarding Referrers for referring Users to LeapNgo and ultimately to the affiliates.

The present invention uses known computer hardware and known basic computer software, along with specific software to run the methods used below.

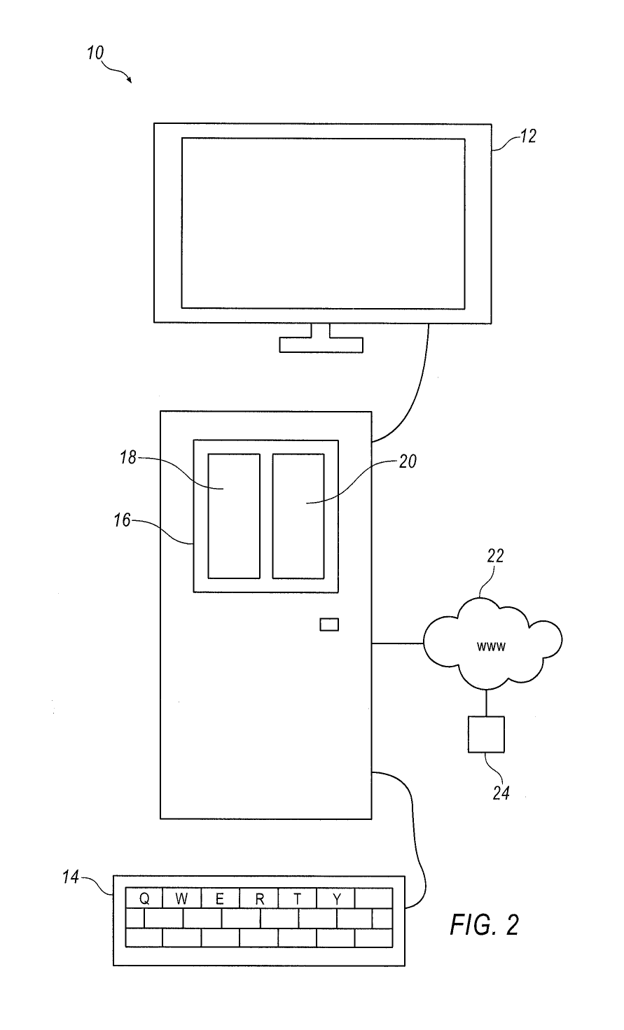

As illustrated in FIG. 2, a basic computer system 10 may be a simple computer that can act as a server as is well known in the arts. Other types of network devices and systems are also within the scope of this invention. The computer system 10 is connected to the world wide web 22 using known methods. The computer system 10 may include a monitor 12, an input device 14 such as a keyboard, and a memory device 16 such as a hard drive. Stored on the memory device 16 is the at least software package 18 and sometimes at least two software packages 18 and 20. As will be described in more detail below, the at least one software package 18 is used to provide a User with rewards. The second software package 20 is used to run a compatible site as described below. A compatible site is described to be any other type of site, such as, but not limited to, a social networking site, an on line classified site, or a dating site. These software packages together, individually, or a combination of one of these software packages and a third software package may be referred to as the LeapNgo system. A social networking site is defined as a website that has a social structure made up of individuals (or organizations) called “nodes”, which are connected by one or more specific types of relationship.

By preferably integrating the at least two software packages 18 and 20, the Users can seamlessly move about from different sites or types of tasks and minimize the number of times User information has to be entered into various sites. The second software package can also be combined with the first software package to create a single software package.

The software packages may be written using any known programming language without deviating from the scope of the invention.

The LeapNgo system can be accessed by Users using any available communication device 24 which allows the user to connect to the world wide web such as a computer, a hand held cellular device, or a personal digital assistant. The particular communication system used by the User is not critical to this invention.

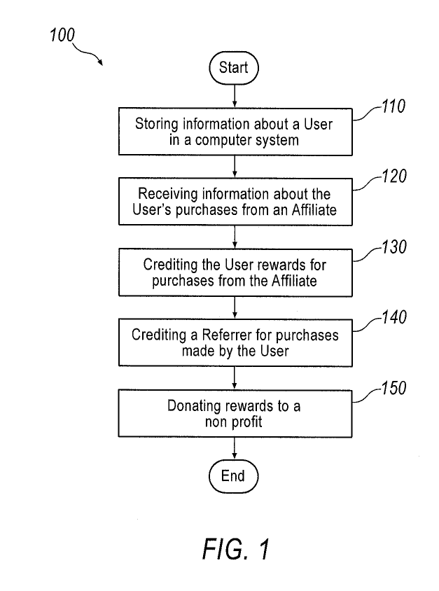

Referring now to FIG. 1, an exemplary block diagram depicting a computer implemented method of providing rewards 100 is now described. Step 110 includes storing information about a User in a computer system 10 using known methods. A User is defined as anyone or entity that uses the method and/or system and may be, for example, an individual, business or non profit. The User uses his personal communication 24 device to enter his personal information. The User must enter sufficient information to properly and uniquely identify the User such as name and contact information. If the information is sufficient to uniquely identify the User, a unique User identification is created. If the User does not enter the necessary information, the User is requested to enter the necessary information before the User can proceed. A home page may be created for each User which may be searched by other Users to facilitate communications between various Users. The home page and other pages may be either free or require a fee to create and/or maintain.

Other information such as the User's sex, marital status, age, ages of any children, location, education, preferences and other likes and dislikes and stores the User likes to shop at may be entered as well. This information can be used to send the User specific and targeted coupons and notices based on his preferences. For example, if the User has young children, coupons and notices for toy stores may be sent to the User. The User may be able to opt out of such notices.

If the User is a business, the home page can be an interactive page to allow other Users to learn more about the business including the type of products and services offered by the User. These business pages may be free or require a fee to create and/or maintain. The business pages are searchable so Users can quickly search other Users to see if any of them are offering the particular type of service or product sought. The pages may also be created in various known ways to facilitate communications between the business page owner and another User.

The User is then encouraged to navigate around the LeapNgo site and access an affiliate either from, for example, the User's home page or an affiliate or mall page which identifies all the stores or affiliates. Search functions are also provided to allow the User to quickly find a particular affiliate offering the type of information, product, or service sought by the User. An affiliate is defined to be an on line store, another User's page, a classified advertisement, a business advertisement, or any other page or site.

As is well known in the art, LeapNgo sends the affiliate information about the User including at least the unique User information as shown in step 120. If the User purchases any products or services from the affiliate, the affiliate will send the system 10 information about the User's activities including at least the amount of money spent by the User and the unique User identification. Other types of information may be sent including the affiliate, the products purchased, the category of products purchased, and other information. This additional type of information can be used to send the User specific coupons or information that the User may find useful. For example, if the User is purchasing sports equipment, the User may want to receive additional coupons for sports equipment or information on sports equipment sales. Monet spent is defined broadly to include actual cash or credit/debit card purchases, use of pay pal accounts, gift cards or whatever else the affiliate selects.

If the affiliate is an outside entity, such as a major department store, there are generally agreements regarding the commission that the outside entity will pay a company for directing web traffic to its site and/or for actual purchases. Typically, the commission is based on a percentage of the money spent and may range from a few percent to over 25%. As shown in step 130, the computer program credits the User rewards for purchases made by the User. The rewards are credited to a non monetary account and can then be used by the User or “paid out” to the User in a variety of different ways. For example, the User may request that he gets paid out in cash in which case he may have money credited to a pay pal account or a debit card, have a check sent to him, or some other means of sending the User cash or a cash equivalent. Additionally, the User may be paid out by allowing the User to purchase electronic gift cards which he may be able to use at various on line stores or affiliates. The gift cards may be purchased at a discount to encourage the User to spend money in an affiliate.

Steps 140 (crediting a Referrer for purchases made by the User) and 150 (donating rewards to a non profit) are optional steps and are described in more detail below. These may be included in the at least one software package 18 or may be additional software packages. Regardless, the same computer system 10 is capable of running these two steps as part of the overall rewards program or independent of the overall rewards program.

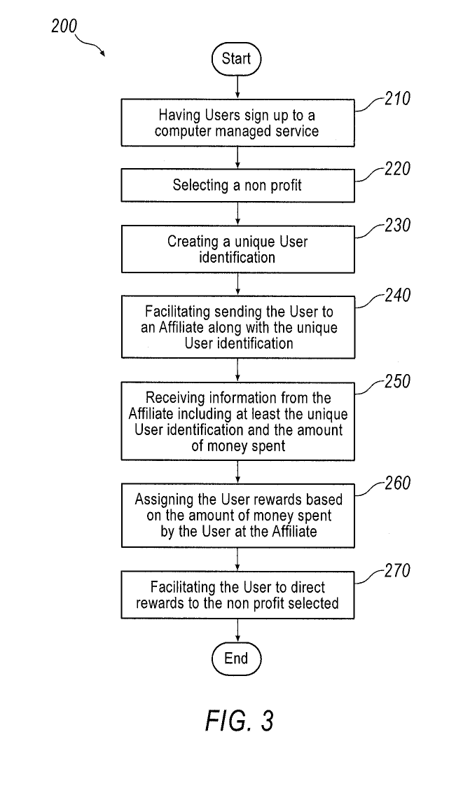

Another aspect of the invention is described in FIG. 3 which depicts in an exemplary block diagram a method relating to donating rewards to a non profit. In this method 200, Users sign up to a computer managed service such as LeapNgo and create user accounts as shown in step 210 and as described above in detail. At some point in the process, the Users select at least one non profit as shown in step 220. This may be performed at the time the User account is set up or at a later date.

In step 230, the system creates a unique user identification as described above.

The system then facilitates sending the User to an affiliate along with the unique user identification as described in step 240 and above in this application. The system receives information back from the affiliate including at least the unique user identification and the amount of money spent by the User as shown in step 250.

In step 260, the system assigns the User rewards based on the amount of money spent by the User at the affiliate.

Lastly, in step 270 the system facilitates the User to direct rewards to the non profit selected. The non profit then collects rewards from one or multiple Users and is paid out in any manner described above. To facilitate easy selection and transfer of the rewards and money, it is preferable that the non profit also be a member of the service and have a unique User identification.

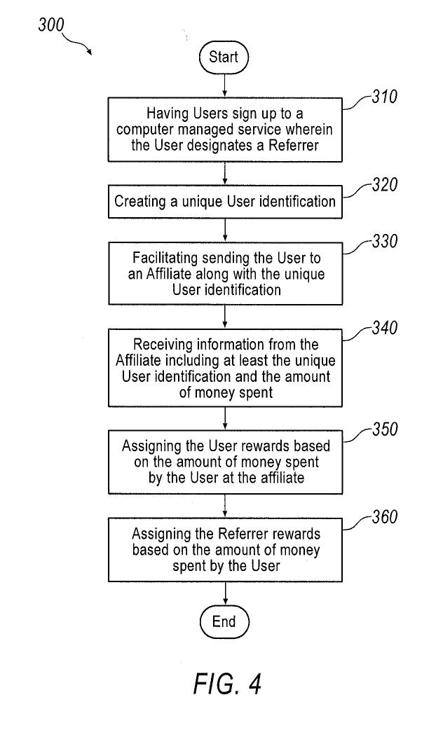

Another benefit of the present invention is that it encourages current Users to refer new Users to join by giving the referring member a reward. FIG. 4 illustrates this process 300 in an exemplary block diagram. In step 310, the User identifies the Referrer by name, or some other type of identifier. In step 320, a unique identifier is created for the User as described above. Steps 310 and 320 may be reversed in that the Referrer may be identified at anytime after the unique identifier is created.

In step 330, the software facilitates sending the User to an affiliate along with the unique User identification. The system then receives information back from the affiliate including at least the unique User identification and the amount of money spent by the User as shown in step 340 and as described above. The amount of money spent can also come from the User creating a business page or any other page on LeapNgo for which the User must pay. In this case, the affiliate may be LeapNgo itself.

Step 350 the system assigns the User rewards based on the amount of money spent by the User at the affiliate. Lastly, in step 360 the software assigns the Referrer rewards based on the amount of money the User spent. This last step incentives Users to get more friends to join LeapNgo and thereby increase the web traffic to the affiliates.

The processes of creating accounts, facilitating sending Users to affiliates, and receiving information back from the affiliates are, in and of themselves well known in the art and are not disclosed in any detail in this application. Programmers skilled in the art are capable of writing programs to do these processes.

While various embodiments have been described above, it should be understood that that they have been presented by way of example only, and not limitation.

We claim:

1. A computer implemented method of providing rewards comprising the steps of:
a) storing information about a User in a computer system;
b) receiving information about the User's purchases from an affiliate;
c) crediting the User rewards for purchases from the affiliate.

2. The method of claim 1 comprising the steps of:
a) crediting a Referrer for purchases made by the User.

3. The method of claim 1 wherein the rewards can directly donated to a non profit selected by the User.

4. The method of claim 1 wherein the rewards can be paid out to the User.

5. The method of claim 2 wherein the Referrer can donate the rewards directly to a non profit selected by the Referrer.

6. The method of claim 2 wherein the rewards can be paid out to the Referrer.

7. The method of claim 1 wherein the information is stored in an integrated system also containing software to run a compatible site.

8. A computer system comprising:
software to provide a User with rewards wherein the software stores information about a User in a computer; receives information about the User's purchases from an affiliate; credits the User rewards for purchases from the affiliate; and
software to run a compatible site, wherein the software to run the compatible site is integrated with the software to provide a User with rewards.

9. A method of donating to non profit comprising:
having Users sign up to a computer managed service;
creating a unique user identification;
facilitating sending the User to an affiliate along with the unique user identification;
receiving information from the affiliate including at least the unique user identification and the amount of money spent;
assigning the User rewards based on the amount of money spent by the User at the affiliate;
facilitating the User to direct rewards to the non profit selected.

10. The method of claim 9 wherein the User selects the non profit at the time the User account is set up.

11. The method of claim 9 wherein the User selects the non profit at some time after the User account is set up.

12. The method of claim 9 wherein the rewards are paid out to the non profit.

13. The method of claim 9 wherein the rewards are paid out to the non profit using electronic means.

14. The method of claim 9 wherein the non profit must be registered with the computer managed service.

15. A method of providing a referral reward comprising:
having Users sign up to a service wherein the User designates a Referrer;
creating a unique user identification;
facilitating sending the User to an affiliate along with the unique user identification;
receiving information from the affiliate including at least the unique user identification and the amount of money spent;
assigning the User rewards based on the amount of money spent by the User at the affiliate;
assigning the Referrer rewards based on the amount of money the User spent.

16. The method of claim 15 further comprising facilitating the User directly donating the user rewards to a non profit selected by the User.

17. The method of claim 15 further comprising facilitating the Referrer directly donating the Referrer rewards to a non profit selected by the Referrer.

18. The method of claim 15 further comprising paying out the User rewards to the User.

19. The method of claim 15 further comprising paying out the Referrer rewards to the Referrer.

20. The computer system of claim 8 wherein the affiliate site is a social networking site.

21. The computer system of claim 8 wherein the affiliate site is a classified section site.

22. The computer system of claim 8 wherein the affiliate site is a dating site.
